(19) United States
(12) Patent Application Publication
(10) Pub. No.: US 2022/0404676 A1
(43) Pub. Date: Dec. 22, 2022

(54) Stack Voltage Based Closed-Loop Feedback Control of Electrochromic Glass

(71) Applicant: SAGE Electrochromics, Inc., Faribault, MN (US)

(72) Inventors: Yigang Wang, Maple Grove, MN (US); Bolei Di, Woodbury, MN (US); Louis Jovelet-Laplace, Minneapolis, MN (US)

(73) Assignee: SAGE Electrochromics, Inc., Faribault, MN (US)

(21) Appl. No.: 17/804,804

(22) Filed: May 31, 2022

Related U.S. Application Data
(60) Provisional application No. 63/212,049, filed on Jun. 17, 2021.

(51) Int. Cl. G02F 1/163; G02F 1/1523

(52) U.S. Cl. CPC G02F 1/163; G02F 1/1523; G02F 2001/1555

(57) ABSTRACT

When transitioning an electrochromic (EC) device between two tint levels, a control unit may repeatedly adjust an applied voltage based on a stack voltage of the EC device. The stack voltage of the EC device may be measured and compared to a reference or target stack voltage. The stack voltage may be measured in any of various methods, such as by measuring it directly, via a measured equivalent series resistance, or via an open circuit voltage measurement. The applied voltage may then be changed or adjusted based on the measured stack voltage and the comparison of the stack voltage to the reference value. This process may be repeated multiple times and may essentially be performed continually until the stack voltage attains the desired level or at least attains a level within a predetermine threshold of the desired level.

### PRIORITY INFORMATION

This application claims benefit of priority to U.S. Provisional Application Ser. No. 63/212,049, entitled “Stack Voltage Based Closed-Loop Feedback Control of Electrochromic Glass,” filed Jun. 17, 2021, and which is incorporated herein by reference in its entirety.

### FIELD OF THE DISCLOSURE

The present disclosure is directed to electrochromic devices, and more specifically to various approaches to control the tint state of electrochromic devices.

### BACKGROUND

An electrochromic device (e.g., one that includes electrically switchable or electrochromic glass) may help to block the transmission of visible light into a building or passenger compartment of a vehicle. Electrochromic devices include electrochromic materials that are known to change their optical properties, such as coloration, in response to the application of an electrical potential, thereby making the device more or less transparent or more or less reflective. For instance, an electrochromic (EC) device can change its optical properties such as optical transmission, absorption, reflectance and/or emittance in a continual but reversible manner on application of voltage. This property enables the EC device to be used for applications like smart glasses, electrochromic mirrors, and electrochromic display devices. Electrochromic glass may include a type of glass or glazing for which light transmission properties of the glass or glazing are altered when electrical power (e.g., voltage/current) is applied to the glass. Electrochromic materials may change in opacity (e.g., may changes levels of tinting) when electrical power is applied.

Typical electrochromic (“EC”) devices generally include a counter electrode layer (“CE layer”), an electrochromic material layer (“EC layer”) which is deposited substantially parallel to the counter electrode layer, and an ionically conductive layer (“IC layer) separating the counter electrode layer from the electrochromic layer, respectively. In addition, two transparent conductive (TC) layers (e.g., two transparent conductive oxide layers) respectively may be substantially parallel to and in contact with the CE layer and the EC layer. The EC layer, IC layer, and CE layer can be referred to collectively as an EC stack, EC thin film stack, etc.

When an electric potential is applied across the layered structure of the electrochromic device, such as by connecting the respective TC, or TCO, layers to a low voltage electrical source, ions, which can include Li+ ions stored in the CE layer, flow from the CE layer, through the IC layer and to the EC layer. In addition, electrons flow from the CE layer, around an external circuit including a low voltage electrical source, to the EC layer so as to maintain charge neutrality in the CE layer and the EC layer. The transfer of ions and electrons to the EC layer causes the optical characteristics of the EC layer, and optionally the CE layer in a complementary EC device, to change, thereby changing the coloration and, thus, the transparency of the electrochromic device.

Control units may control electrochromic glass by controlling a voltage or current applied to the electrochromic glass. Traditionally, EC glass control is generally based on a charge-counting control strategy. Charge-counting control strategy may be considered an open-loop control strategy, i.e., its performance depends heavily on the characteristics of the particular EC device. However, there are frequent mismatches between the model used to control the EC device and the actual EC device. In many systems different types and sizes of electrochromic glass may be used, and the different types and sizes of electrically switchable glass may require different levels of current and/or voltage to achieve similar levels of opacity. Thus, in systems comprising various sizes and types of electrochromic glass, configuration and control parameters for respective control units that control different pieces of electrochromic glass may need to take into account differences in characteristics of the electrochromic glass (e.g., different required voltage levels or currents) to achieve particular opacity levels. For example, traditionally such system may maintain a large database of parameters for various configurations of electrochromic glass units.

### SUMMARY

Stack voltage based feedback control of EC devices as described herein may involve continually or repeatedly adjusting an applied voltage based on the stack voltage of an electrochromic (EC) device. For example, in one embodiment, the stack voltage of the EC device may be measured repeatedly and compared to a reference (e.g., desired or target) value for the stack voltage. The applied voltage may then be changed or adjusted based on the measured stack voltage and the comparison of the stack voltage to the reference value. This process may be repeated multiple times and may be considered to be applied continually until the stack voltage attains the desired level or at least attains a level within a predetermine threshold of the desired level.

Thus, rather than apply a constant level of applied voltage until the EC device achieve a desired level of transmission (e.g., tint or opacity), the applied voltage may be adjusted continually (or at least repeatedly) until the stack voltage reaches the desired level to achieve the desired EC glass transmission level (e.g., tint or opacity). Systems utilizing stack voltage based feedback control for EC devices may, in some embodiments, be able to use a higher voltage as an applied voltage (i.e., with well overall risk of damaging the EC device) than a traditional system, thereby potentially achieving a faster switching time (e.g., between two different EC tints). Additionally, stack voltage based feedback control may result in EC devices that are less sensitive to variations in EC stack characteristics (e.g., wire length, overall size, aspect ratio, leakage, etc.). For instance, stack voltage based feedback control may obviate the need to maintain and reference a large database of parameters keyed to particular EC models or particular EC devices. An insulated glass unit (IGU) is one example of an EC device configured for different tint levels that may be controlled using the systems and techniques described herein.

Additionally, utilizing stack voltage based feedback control may make an EC system less sensitive to the nonlinear properties of individual IGU models, as well as to environmental changes (e.g., temperature, wind, etc.) according to some embodiments.

An EC system utilizing stack voltage based feedback control may involve any of various methods for measuring or otherwise determining a stack voltage for an EC stack. For example, in some embodiments, stack voltage may be measured directed via a measurement point on the IGU that connects the top and bottom layers, such as a measurement point that connects a top indium tin oxide (ITO) and a bottom ITO layer directly or a measurement point that connects a top transparent conductive oxide (TCO) layer with a bottom TCO layer directly. Such a measurement point may allow an EC control unit to read the stack voltage of the IGU directly. In other embodiments, an EC control unit may be configured to calculate a stack voltage for an EC device by first measuring the equivalent series resistance (ESR) and determining the stack voltage from the measured ESR and the applied voltage being used. In yet other embodiments, an EC control unit may be configured to determine or estimate the stack voltage based on an open circuit voltage (OCV) measurement. However, in some embodiments, the EC control unit may temporarily introduce a high impedance or a high resistance into the system circuit thereby causing the circuit to behave like an open circuit allowing a OCV to be measured. After measuring the OCV, the EC control unit may then determine or estimate a stack voltage for the EC device.

### BRIEF DESCRIPTION OF THE DRAWINGS

FIG. 1 illustrates an example electrochromic (EC) device, according to some embodiments.

FIGS. 2A and 2B are graphs illustrating the effects of utilizing stack voltage based feedback control of an EC device, according to some embodiments.

FIG. 3 illustrates an example electrochromic (EC) system including a control system for configured to control the transmission state of one or more EC devices, according to some embodiments.

FIG. 4 logical block diagram illustrating the steps and features of stack voltage based feedback control, according to some embodiments.

FIG. 5 illustrates one example embodiment of an electrochromic (EC) system configured for stack voltage determination based on direct measurement, according to some embodiments.

FIG. 6 illustrates one example embodiment of an electrochromic (EC) system configured for stack voltage determination based on equivalent series resistance, according to some embodiments.

FIG. 7 illustrates one example embodiment of an electrochromic (EC) system configured for stack voltage determination based on open circuit voltage, according to some embodiments.

FIG. 8 is a graph illustrating transition uniformity of the OCV measurement compared to a control IGU average stack voltage, according to one example embodiment.

FIG. 9 is a graph illustrating transition uniformity of the OCV measurement compared to a control IGU average stack voltage, according to one example embodiment.

FIG. 10A and FIG. 10B are graphs illustrating an example embodiment of P parameter variation for the example PI control algorithm described above regarding the adaptable PI control for varying stack voltages.

FIG. 10C is a graph illustrating the I parameter variation for the example PI control algorithm described above regarding the adaptable PI control for varying stack voltages, according to one embodiment.

FIG. 11 illustrates an example computer system, according to some embodiments.

While embodiments are described herein by way of example for several embodiments and illustrative drawings, those skilled in the art will recognize that the embodiments are not limited to the embodiments or drawings described. It should be understood that the drawings and detailed description thereto are not intended to limit embodiments to the particular form disclosed, but on the contrary, the intention is to cover all modifications, equivalents and alternatives falling within the spirit and scope as defined by the appended claims. The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). The words “include,” “including,” and “includes” indicate open-ended relationships and therefore mean including, but not limited to. Similarly, the words “have,” “having,” and “has” also indicate open-ended relationships, and thus mean having, but not limited to. The terms “first,” “second,” “third,” and so forth as used herein are used as labels for nouns that they precede, and do not imply any type of ordering (e.g., spatial, temporal, logical, etc.) unless such an ordering is otherwise explicitly indicated.

“Based On.” As used herein, this term is used to describe one or more factors that affect a determination. This term does not foreclose additional factors that may affect a determination. That is, a determination may be solely based on those factors or based, at least in part, on those factors. Consider the phrase “determine A based on B.” While B may be a factor that affects the determination of A, such a phrase does not foreclose the determination of A from also being based on C. In other instances, A may be determined based solely on B.

The scope of the present disclosure includes any feature or combination of features disclosed herein (either explicitly or implicitly), or any generalization thereof, whether or not it mitigates any or all of the problems addressed herein. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

### DETAILED DESCRIPTION

For example, in some embodiments, a control unit may control respective electrochromic glass units to any of various tint levels. However, due to the different characteristics between the different electrochromic glass units (IGUs), different voltages and current levels may need to be applied to the different IGUs (or other EC devices) to achieve similar tint levels. As an example, a first smaller EC device with a first set of characteristics may require X volts be applied to achieve a particular tint level, whereas another EC device with a different size and different characteristics may require Y volts be applied to achieve the same tint level.

Changes in coloration of a medium, which can include one or more layers, stacks, devices, etc., can be described as changes in the “transmission” level of the medium. As used hereinafter, transmission refers to the permittance of the passage of electromagnetic (EM) radiation, which can include visible light, through the medium, and a “transmission level” of the medium can refer to a transmittance of the medium. Where a medium changes transmission level, the medium may change from a clear transmission state (“full transmission level”) to a transmission level where a reduced proportion of incident EM radiation passes through the medium. Such a change in transmission level may cause the coloration or tint of the medium to change. For example, a medium which changes from a full transmission or tint level to a lower transmission or tint level may be observed to become more opaque, darker in coloration or tint etc.

As will be described in more detail subsequently, stack voltage based feedback control may involve repeatedly measuring the stack voltage of an EC device, comparing the measured stack voltage with a reference (or target) stack voltage to determine a voltage stack error (e.g., voltage stack error=reference stack voltage−measured stack voltage) and calculating an applied voltage level for the IGU. A system utilizing stack voltage based feedback control may be configured to use any of a number of varying overall control structures and systems. For instance, in one example embodiment a control unit may utilize adaptive non-linear PID tuning in order to adapt a PID control system for use with stack voltage based feedback control. For instance, instead of using basic PID control, such as may be based on the following equation:

V_{applied}=Kₚ*V_{stack}_{ₑᵣᵣₒᵣ}+Kᵢ*∫(V_{stack}_{ₑᵣᵣₒᵣ})+K_{d}*diff

a control unit may be configured to adapt the PDI parameters to better address the non-linear aspects of EC devices. For example, other example equations for use when adapting PID control for use with stack voltage based feedback control include:

V_{applied}=V_{target}+P(V_{target}−V_{stack})+[I∫(V_{target}−V_{stack})dt]e^{-dt}

and

V_{applied}=clip{V_{target}+P(V_{target},V_{stack})(V_{target}−V_{stack})+I(V_{target},V_{stack})(V_{target}−V_{stack})dt,Vₘᵢₙ,Vₘₐₓ}

Thus, the P and I parameters of the PID control system may be continuously adapted throughout the EC transition cycle (i.e., when transitioning between two transmission or tint levels), as will be described in more detail subsequently. Please note while described herein in some detail, a PID control based system is merely one example technique of utilizing stack voltage based feedback control and that other methods may be used according to various embodiments.

One potential advantage to utilizing stack voltage based feedback control may be the ability to control many different configurations of EC devices (and IGUs) without the need to store and access a large set of parameters for each configuration. Traditionally, control units use a set of parameters (e.g., voltage requirements, wire resistance levels, wire lengths, IGU aspect ratio, size, leakage, etc. describing how to control different EC devices. For example, traditional control unit may access the parameters from a database and use those parameters for such characteristics as what applied voltage to use and for how long to transition a particular EC device between two transmission or tint levels. In contrast, a control unit configured to use stack voltage based feedback control, as described herein, may be able to control many different types and configurations of EC devices (including different types and/or sizes of IGUs) without the need to have and/or access a database containing specific parameters for each particular EC device or device type.

In some embodiments, a control unit configured to utilize stack voltage based feedback control may only need to have a few parameters for each EC device and may therefore be able to greatly reduce and or minimize the number and size of stored parameters required to control different types of EC devices. For instance, utilizing stack voltage based feedback control a control unit may automatically adapt and/or adjust to the characteristics of an EC device, such as by monitoring (e.g., measuring) the average stack voltage of an IGU and adapting the applied voltage level accordingly when transitioning the IGU between two transmission or tint levels.

Additionally, a control unit configured to utilize stack voltage based feedback control may be less sensitive (than a control unit using traditional techniques) to such things as different EC stack configurations, IGU variations (e.g., wire length, size, aspect ratio, leakage, etc.), model nonlinearity, and environmental changes (temperature, wind, etc.), etc. A further potential advantage of utilizing stack voltage based feedback control may be the ability to apply higher levels of voltage with less risk to inadvertently damaging the IGU, according to some embodiments.

Thus, by utilizing a closed loop control system, stack voltage based feedback control as described herein, may allow a single control unit to adapt to varying IGU characteristics and conditions, according to various embodiments.

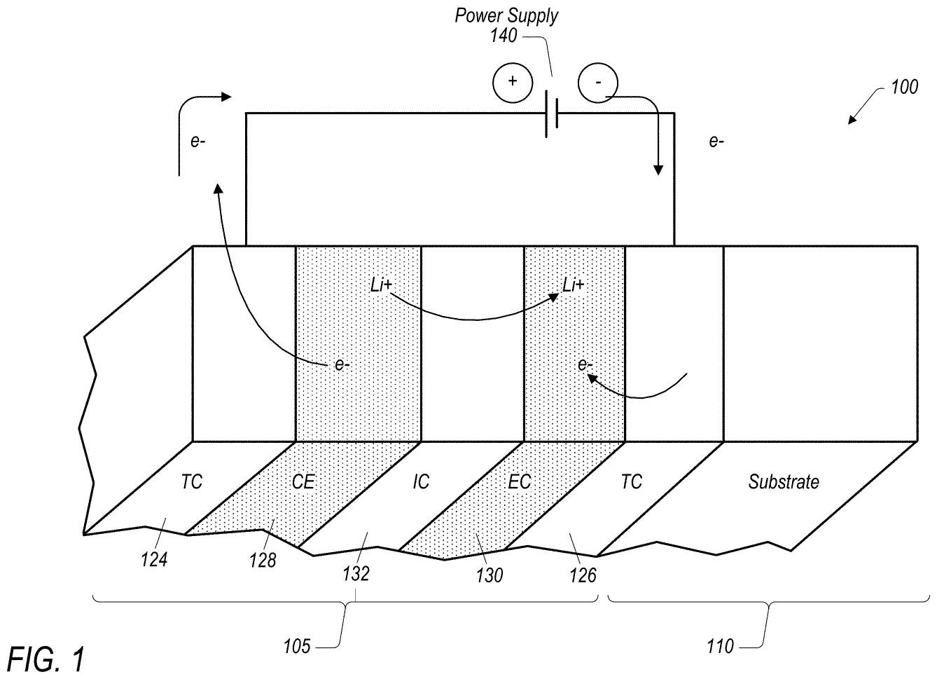

FIG. 1 shows an example electrochromic (EC) system. In this example, electrochromic system 100 may include electrochromic device 105 secured to substrate 110. For instance, electrochromic device 105 may include a thin film which may be deposited on to substrate 110. Electrochromic device 105 may include includes a first transparent conductive (TC) layer 124 and the second TC layer 126 in contact with substrate 110. In some embodiments, TC layer 124 and TC layer 126 may be, or may include, transparent conductive oxide (TCO) layers. Substrate 110 may include one or more optically transparent materials, e.g., glass, plastic, and the like. The electrochromic device 120 may also include counter electrode (CE) layer 128 in contact with the first TC layer 124, electrochromic electrode (EC) layer 130 in contact with the second TC layer 126, and ionic conductor (IC) layer 132 “sandwiched” in-between CE layer 128 and EC layer 130. Electrochromic system 100 may include power supply 140 which may provide regulated current or voltage to electrochromic device 105. Transparency of electrochromic device 105 may be controlled by regulating density of charges (or lithium ions) in CE layer 128 and/or EC layer 130 of electrochromic device 105. For instance, when electrochromic system 100 applies a positive voltage from power supply 140 to the first TC 124, lithium ions may be driven across IC layer 132 and inserted into EC layer 130. Simultaneously, charge-compensating electrons may be extracted from CE layer 128, flow across the external circuit, and get inserted into EC layer 130. Transfer of lithium ions and associated electrons from CE layer 128 to EC layer 130 may cause electrochromic device 105 to become darker—e.g., the visible light transmission or % T of electrochromic device 105 may decrease. Reversing the voltage polarity may cause the lithium ions and associated charges to return to their original layer, CE layer 128, and as a result, electrochromic device 105 may return to a clear state—e.g., the visible light transmission or % T of electrochromic device 105 may increase.

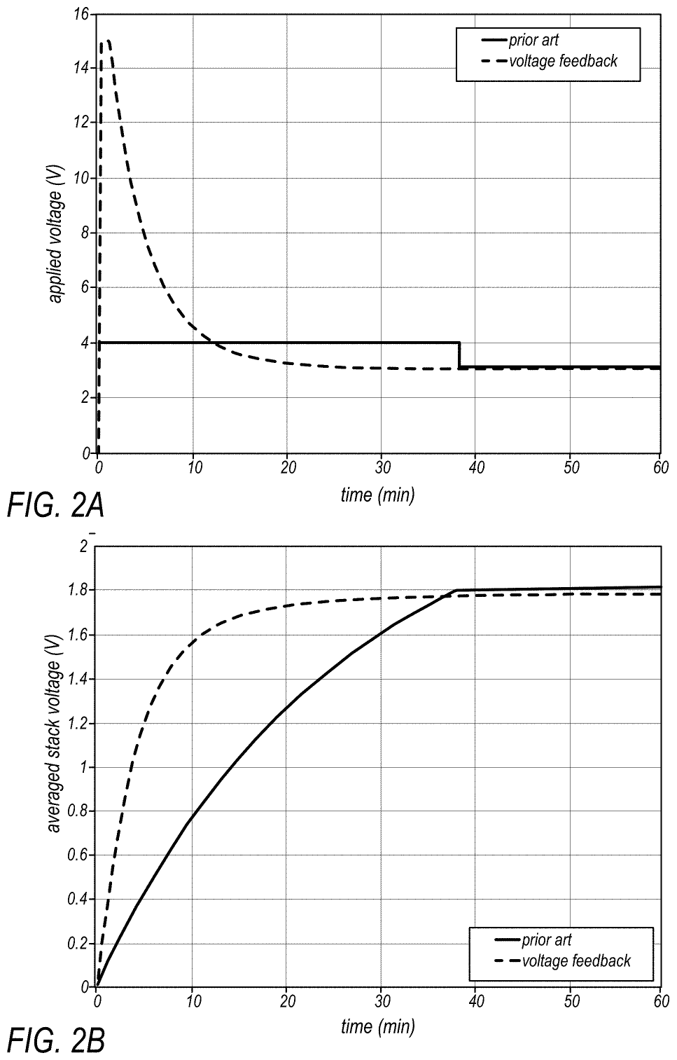

FIGS. 2A and 2B are graphs illustrating the effects of utilizing stack voltage based feedback control of an EC device, according to some embodiments. The graph illustrated in FIG. 2A compares the applied voltage levels when transitioning an EC device to a tinted state. The solid line in FIG. 2A represents the applied voltage when controlling the EC device in a prior or traditional manner, such as by applying a constant level of applied voltage until the stack voltage reaches a desired level (e.g., representing a particular level of tinting) and then dropping the applied voltage to a “holding” level. As illustrated in FIG. 2A, when utilizing traditional EC control according to one example, a constant voltage of 4 v may be applied for approximately 38 seconds before dropping the applied voltage to a holding level of approximate 3 v.

In contrast, the dashed line represents the applied voltage when utilizing stack voltage based feedback control of the EC device. According to some embodiments, when utilizing stack voltage based feedback control a higher level of voltage may be applied initially, but then continually (or repeatedly) adjusted based on the stack voltage. For example, as illustrated in FIG. 2, an initial voltage of 15 v may be applied, but then continually adjusted (downward) as the stack voltage approaches the desired level—representing the desired level of tinting.

The graph of FIG. 2B illustrates the stack voltage for the same EC device during the transition described above. Once again, the solid line represents the stack voltage when utilizing a traditional method by applying a constant voltage, while the dashed line represents the stack voltage of a system utilizing stack voltage based feedback control as described herein. Thus, when utilizing the techniques described herein, the stack voltage may approach the target level much quicker than when utilizing traditional techniques, according to some embodiments. For instance, according to the example embodiment illustrated in FIG. 2B, the stack voltage may reach an average level of 1.6 v in approximately 10 minutes when utilizing stack voltage based feedback control while it may take approximately 30 minutes to reach the same level utilizing traditional techniques.

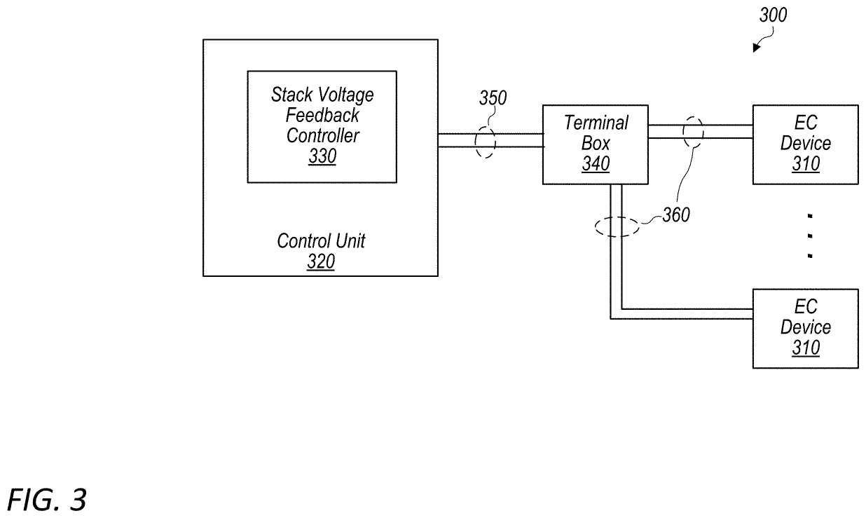

FIG. 3 illustrates an example electrochromic (EC) device including a control system for configured to control the transmission state of the EC device, according to some embodiments. As shown in FIG. 3, EC system 300 may include control unit 320 coupled with one or more EC devices 310. Control unit 320 may be housed, for example, in a control panel. Control unit 320 may include one or more power supplies, controllers, data acquisition systems as well as stack voltage feedback controller 330. Control unit 320, stack voltage feedback controller and/or one or more other controllers each may further have one or more processors and memory. Control unit 320 as well as its one or more power supplies, may receive electric power, for example, from external outlets, and provide output voltages (e.g., an applied voltage) to EC device(s) 310 (such as via terminal box 340). EC device(s) 310 may be installed within one or more window frames, for instance, to implement one or more smart glass units. Control unit 320 and EC device(s) 310 may be coupled through one or more components, such as terminal box 340 and lines/cables 350 and 360. For example, in some embodiments, terminal box 340 may be a junction box for interfacing cables between control unit 320 and EC device(s) 310, which may be useful especially when control unit 320 controls multiple EC devices 310 as shown in FIG. 3.

Cables 350 and 360 may carry voltages and currents from control unit 320 to EC device(s) 310. In some embodiments, EC system 300 may use different cables to fit corresponding voltage and/or current levels. For example, EC system 300 may use a 12-conductor bundled cable to connect control unit 320 with terminal box 340, and thinner frame cables from terminal box 340 to EC device(s) 310. Moreover, control unit 320 may measure and/or monitor one or more voltages and/or currents flowing through or across EC device 310, such as stack voltage, applied voltage, charge voltage, etc. In some embodiments, the current and/or voltage may be captured by one or more sensors and fed back to control unit 320—either along cables 350 and 360 or along separate cables leading directly from an EC device to control unit 320 (not shown in FIG. 3). For instance, in some embodiments, a stack voltage may be measured by one or more sensors attached to an EC device, allowing control unit 320 (and/or stack voltage feedback controller 330) to determine a current stack voltage for the EC device. In other embodiments, control unit 320 and/or stack voltage feedback controller 330 may be configured to determine (or estimate) a stack voltage for an EC device without separate sensors attached to the EC device.

Stack voltage feedback controller 330 may, in some embodiments, represent electronic circuitry, computer hardware (such as one or more processors and memory) and/or one or more software modules, as will be described in more detail subsequently. Note that, for the purpose of illustrating, FIG. 3 is only a simplified diagram showing basic configurations of an EC system. In some embodiments, EC system 300 may include one or more additional components not shown in FIG. 3. Further, in some embodiments, besides terminal box 340, cables 350 and cables 360, control unit 320 may be coupled with EC device(s) 310 through various wired (e.g., through cables, wires, contacts, transformers, optical fibers, etc.) and/or wireless connections.

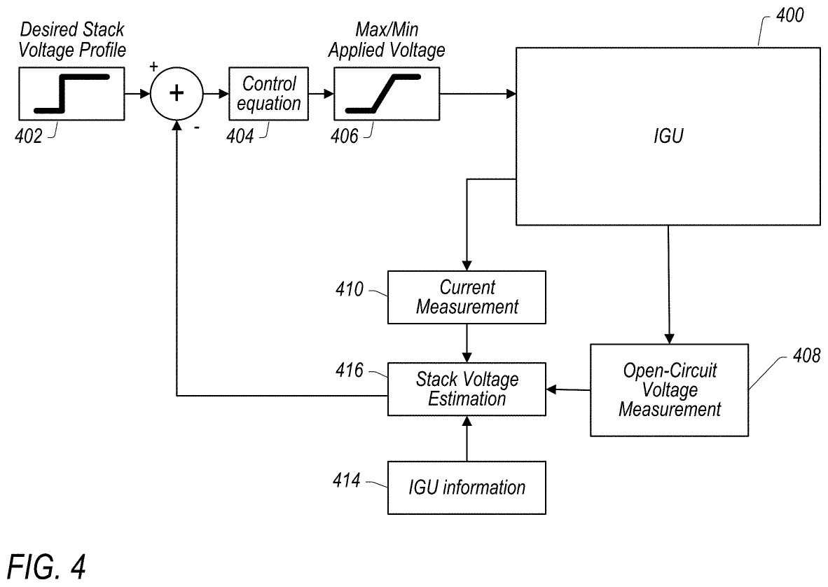

FIG. 4 is a logical block diagram illustrating various features and aspects of stack voltage based feedback control, according to some embodiments. As described above, in some embodiments, control unit 320 may be configured to continually (or repeatedly) monitor the stack voltage of IGU 400 and adjust an applied voltage used to transition the EC device or IGU between two transmission or tint levels. The applied voltage may be adjusted based on a comparison of the stack voltage and a reference or desired stack voltage, such as represented by desired stack voltage profile 402. As illustrated in FIG. 4, a stack voltage estimation 416 may be determined based on one or more inputs or calculations. For example, in some embodiments, stack voltage estimation 416 may be determined based, at least in part, on a current measurement 410 as well as IGU information 414 (e.g., bus-bar separation information, leakage ladder information, etc.). Additionally, stack voltage estimation 412 (such as an IGU Edge stack voltage estimation) may be at least partially based on an open-circuit voltage measurement 408.

While displayed in FIG. 4 as an estimation, in some embodiments, stack voltage 412 may represent a directly measured stack voltage, a measured edge stack voltage, or a calculated stack voltage, according to various embodiments. Similarly, while illustrated as an actual open-circuit voltage measurement, in some embodiments open-circuit voltage measurement 406 may be (or may represent) a measurement made during a simulated open circuit, such as by applying a high impedance or high resistance to the circuitry of IGU 400 such that the circuitry behaves as if there were an open circuit.

As illustrated in FIG. 4, the average stack voltage estimation 412 may be compared to, or combined with, desired stack voltage 402 and fed into control equation 404 to determine how to adjust applied voltage 406 being applied to the circuitry of IGU 400. For example, in one embodiment control equation 404 may represent an adaptive PI control system with varying P and I parameters based on the stack voltage and the reference or target voltage, as will be described in more detail subsequently.

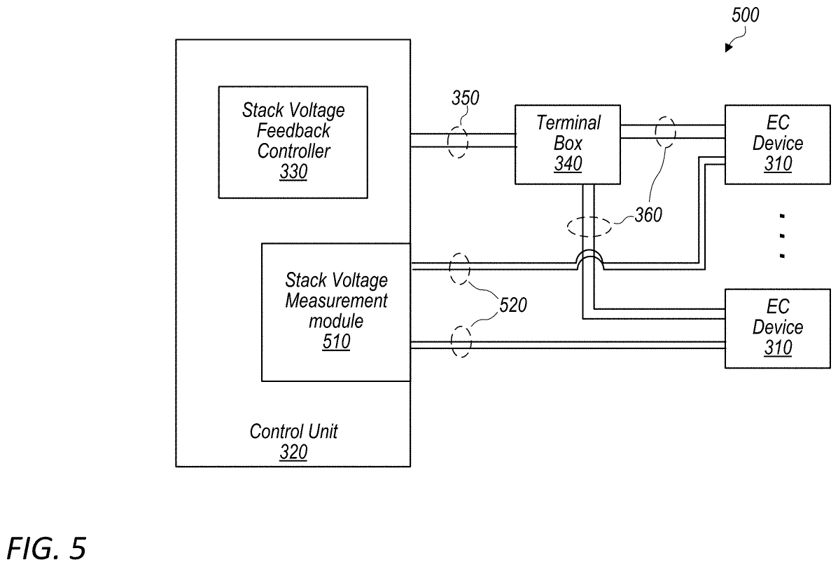

Please note that while FIG. 5 illustrates an IGU, the details, methods, systems and/or techniques described above regarding FIG. 5 also apply to other EC devices according to various embodiments.

FIG. 5 illustrates one example embodiment of an electrochromic (EC) system configured for stack voltage determination based on direct measurement, according to some embodiments. As described above regarding FIG. 3, an EC system, such as system 500, may include control unit 320 coupled with one or more EC devices 310. Control unit 320 may include one or more power supplies, controllers, data acquisition systems as well as stack voltage feedback controller 330. Control unit 320, stack voltage feedback controller and/or one or more other controllers each may further have one or more processors and memory. Control unit 320 as well as its one or more power supplies, may receive electric power, for example, from external outlets, and provide output voltages (e.g., an applied voltage) to EC device(s) 310 via terminal box 340 and cables 350 and 360. Thus, cables 350 and 360 may carry voltages and currents from control unit 320 to EC device(s) 310.

As described above, in some embodiments, control unit 320 may be configured to determine a stack voltage for an EC device (or IGU) based at least in part on directly measuring the stack voltage. Thus, in some embodiments, control unit 320 may include a stack voltage measurement module 510 configured to determine stack voltage for one or more EC devices based at least in part on a direct voltage measurement for the EC devices. For instance, in some embodiments EC system 500 may include cables 520 connecting each EC device 310 with control unit 320. While illustrated in FIG. 5 as bypassing terminal box 340, in some embodiments cables 520 may be routed through terminal box 340.

In some embodiments, a stack voltage may be captured by one or more sensors and fed back to control unit 320 along cables 520. For instance, in some embodiments, a stack voltage may be measured by one or more sensors attached to an EC device, allowing control unit 320 (and/or stack voltage feedback controller 330) to determine a current stack voltage for the EC device. In other embodiments, control unit 320 and/or stack voltage feedback controller 330 may be configured to determine (or estimate) a stack voltage for an EC device using cables 520 without separate sensors attached to the EC device. For instance, one or more sensors or measurement devices may be included in control unit 320 (or within stack voltage measurement module 510) that may allow control unit 320 and/or stack voltage measurement module 510 to determine a stack voltage for one or more EC devices using cables 520. The determined stack voltage may then be provided (or at least used by) stack voltage feedback controller 330 when determining a voltage level to apply to one or more EC devices, such as to change a tint level for the one or more EC devices.

Stack voltage measurement module 510 may, in some embodiments, represent electronic circuitry, computer hardware (such as one or more processors and memory) and/or one or more software modules, as will be described in more detail subsequently. Note that, for the purpose of illustrating, FIG. 5 is only a simplified diagram showing basic configurations of an EC system. In some embodiments, EC system 500 may include one or more additional components not shown in FIG. 5. Further, in some embodiments, besides terminal box 340 as well as cables 350, 360 and 520, control unit 320 may be coupled with EC device(s) 310 through various wired (e.g., through cables, wires, contacts, transformers, optical fibers, etc.) and/or wireless connections.

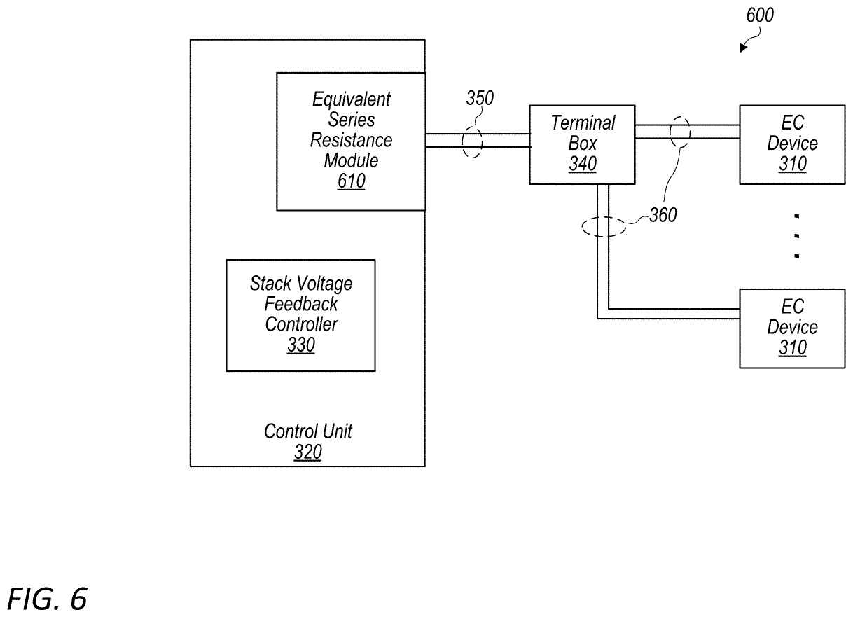

FIG. 6 illustrates one example embodiment of an electrochromic (EC) system configured for stack voltage determination based on equivalent series resistance, according to some embodiments. As described above, in some embodiments control unit 320 may be configured to determine a stack voltage for one or more EC devices based (at least in part) on an equivalent series resistance (ESR) value. For example, control unit 320 may measure ESR in order to determine, calculate or estimate a stack voltage rather than directly measuring stack voltage. An equivalent series resistance may represent and/or include resistance associated with wires, contacts, and bus bars, and equivalent internal resistance of an EC device 310, according to some embodiments.

Thus, in some embodiments control unit 320 may include equivalent series resistance module 610 configured to determine (or help determine) a stack voltage for an EC device based at least in part on an ESR value. For example, control unit 320 and/or ESR module 610 may measure the ESR of an EC device 310 using a high frequency signal. In some embodiments, control unit 320 may be configured to send a high frequency signal, such a sine wave signal, into the EC device circuit along cables 350 and/or 360 (via terminal box 340) to determine the ESR of the EC device. In some embodiments, an AC high frequency signal may be applied to the control voltage terminals, which may normally carry DC voltage, via cables 350 and consequently cables 360, thus allowing measurement of the ESR. In some embodiment, ESR module 610 may be configured to apply, or initiate the application of, such a high frequency signal to the EC system circuitry.

The exact frequency of the high frequency signal used to determine the ESR may vary from embodiment to embodiment. For instance, the sine wave signal may vary from 100 Hz to 10 kHz to over 100 kHz, according to various embodiments. Using the high frequency signal, the control unit may determine an ESR for the EC device and from the ESR may determine (e.g., calculate or estimate) a stack voltage for the EC device.

In some embodiments, control unit 320 and/or ESR module 610 may be configured to determine the stack voltage from the ESR and the applied voltage. For instance, the ESR of an EC device may be considered to approximate the difference between the stack voltage and the applied voltage of the EC device circuit, according to some embodiments. The ESR (and therefore the stack voltage estimation) may be determined in real (or near real) time, according to some embodiments.

In some embodiments, determining the stack voltage via an ESR value for the EC device may not require any modifications to existing EC device circuitry. Instead, software control modifications (such may be implemented within control unit 320, ESR module 610 and/or stack voltage feedback controller 330) may utilize existing hardware and circuitry to measure the ESR and determine the stack voltage therefrom.

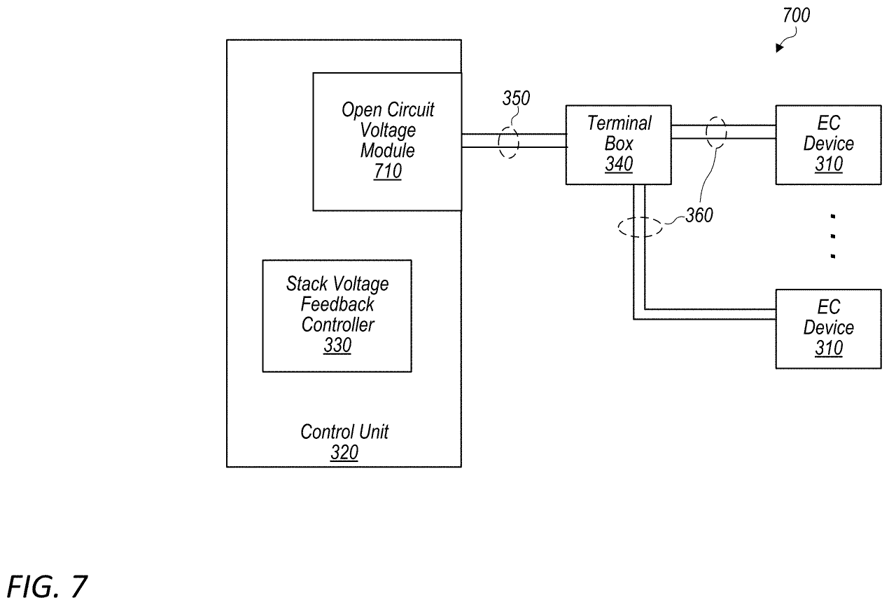

FIG. 7 illustrates one example embodiment of an electrochromic (EC) system configured for stack voltage determination based on open circuit voltage, according to some embodiments. While described above as measuring the stack voltage directly or calculating the stack voltage based on an ESR value, in some embodiments, control unit 320 may be configured to determine the stack voltage of an EC device 310 indirectly based at least in part on an open-circuit voltage (OCV) measurement for the EC device. For instance, in some embodiments control unit 320 may include OCV module 710 configured to determine stack voltage for one or more EC devices based at least in part on OCV measurement(s) for the one or more EC devices.

For example, in some embodiments control unit 320 and/or OCV module 710 may be configured to open a circuit on the EC system and measure an OCV. In other embodiments however, control unit 320 and/or OCV module 710 may be configured to utilize a high impedance and/or a high resistance to cause the EC device circuit to behave electrically as if there was an actual open circuit. Thus, in some embodiments, control unit 320 and/or OCV module 710 may be configured to apply a high impedance and/or a high resistance to one of the control terminals, such as via cables 350 (and/or via terminal box 340 to cables 360) of the EC device and measure an OCV for the EC device. In some embodiments, the high impedance and/or high resistance may by applied for very short period of time (e.g., just enough time to effectively measure the open-circuit voltage). Thus, in some embodiments, control unit 320 and/or OCV module 710 may perform some functions of, or perform similarly to, a power supply unit for the EC device.

In some embodiments, especially for large IGUs (or other EC devices), the measured OCV may represent an edge voltage rather than an overall average stack voltage for the IGU. In general, EC device edge stack voltage and EC device average stack voltage may always be different from each other, according to some embodiments. For instance, during a transition phase (e.g., when changing EC device transmission or tint levels) the different between an EC device's edge stack voltage and the EC device's average stack voltage may be large and that difference may slow down or otherwise interfere with the IGU tinting and/or clearing process (e.g., causing the process to stop too early).

During a holding period (e.g., while maintain a particular tint level), the difference between an EC device's edge stack voltage and average stack voltage may affect the holding accuracy, such as by causing the transmission or tint to be lighter than desired during the holding period, according to some embodiments. Thus, control unit 320 and/or OCV module 710, may be configured to determine an average stack voltage differently for different EC devices according to different embodiments. Alternatively, in some embodiments, the edge voltage may be usable as an average stack voltage for the purposes of achieving a desired transmission or tint for an EC device.

In some embodiments, determining the stack voltage via an OCV value for an EC device may not require any modifications to existing EC device circuitry. Instead, software control modifications, such as within control unit 320, stack voltage feedback controller 330 and/or OCV module 710, may utilize existing hardware and circuitry to measure OCV for EC device and determine the stack voltage therefrom. In some embodiments, at low voltage levels, EC device may equal (or approach or approximate) the control voltage (V_{c}).

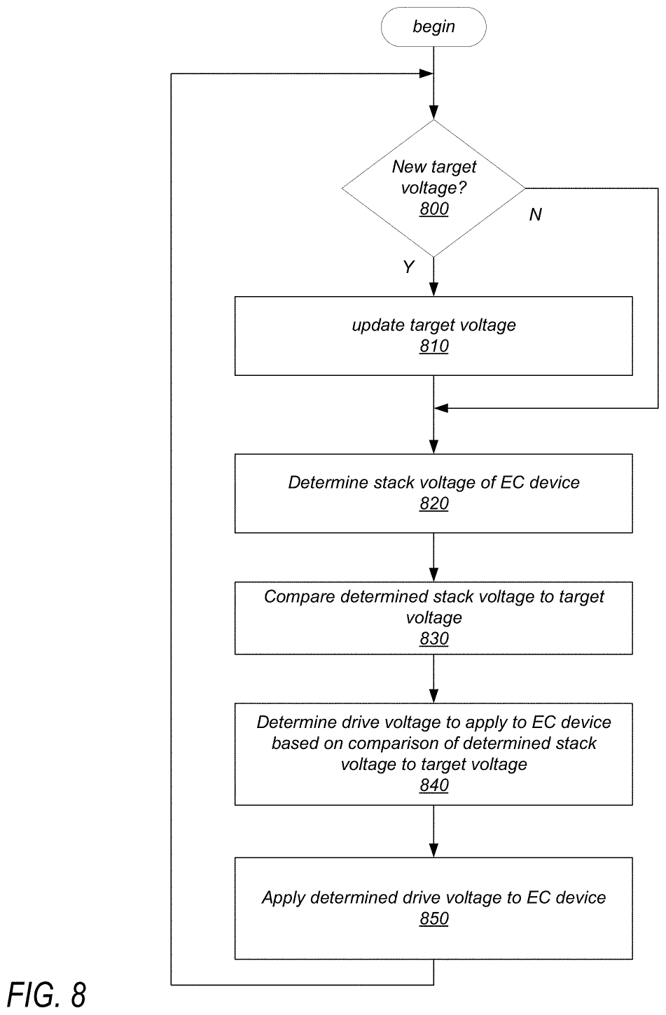

FIG. 8 is a flowchart illustrating one embodiment of a method for stack voltage based feedback control as described herein. As noted above, a control unit 320 may be configured to cause an IGU (or other EC device) to change its transmission level, such as to tint to a darker color. Control unit 320 may determine whether to change the tint, and therefore the stack voltage, of an EC device 310. For example, in some embodiments, a person may use a switch, such as a remote control or wall mounted unit, to control the tint level of a particular EC device and in response control unit 320 may receive a signal or command to change the tine level of the EC device. Thus, control unit 320 may determine whether to use a new target voltage (e.g., a new target stack voltage) for EC device 310, as illustrated by the positive output of decision block 800. In response to determining that a new (i.e., different) target stack voltage should be used for EC device 310, control unit 320 (and/or a particular module within control unit 320, such as stack voltage feedback controller 330) may update a target voltage for EC device 310, as in block 810. In some embodiments, updating the new target voltage may include saving a new value to a particular hardware register, software memory location, or other location within control unit 320 (and/or within one or more sub modules within control unit 320, such as stack voltage feedback controller 330).

While described herein regarding control unit 320 changing tint for a single EC device, in some embodiments, control unit 320 may control (e.g., change a tint level of) multiple EC devices. Control unit 320 may control multiple EC devices so that each device has a different, respective tint level or may use a single tint level for all controlled EC device. In general, control unit 320 may be configured to one or more EC devices to be maintained at a single tint level while allowing other EC device to have different, individual (respective) tint levels. Thus, in some embodiments, control unit 320 may be configured to maintain one or more target tint levels each corresponding to one or more EC devices.

As shown in block 820, control unit 320 may be configured to determine a stack voltage for the EC device. As will be described in more detail subsequently, control unit 320 may utilize any of various suitable methods and/or techniques to determine a current stack voltage of the EC device.

### Determining Stack Voltage by Direct Measurement

In some embodiments, control unit 320 may be configured to directly measure a stack voltage for the EC device. For example, an EC device (or IGU) may have a sensor or other measurement point at which the stack voltage may be measured directly by control unit 320. In some embodiments, such a measurement point may connect a top and a bottom transparent conductor oxide (TCO) or indium tin oxide (ITO) layers allowing a direct measurement of the stack voltage. In some embodiments measuring the stack voltage directly at a measurement point, such as one connecting two TCO or ITO layers, may require an individual set of signals from each EC device (or IGU) to control unit 320 in order for control unit 320 to proper manage multiple EC devices. Additionally, directly measuring the stack voltage may involve estimating an overall average stack voltage for the IGU based on the voltage at the measurement point rather than simply using the measured value as a stack voltage.

### Determining Stack Voltage by Equivalent Series Resistance

In other embodiments, control unit 320 may be configured to determine a stack voltage by estimating the stack voltage based at least in part on an equivalent series resistance (ESR) for the EC device. For instance, control unit 320 may be configured to determine the stack voltage of the EC device indirectly using an equivalent series resistance (ESR) value for the EC device. Thus, in some embodiments, control unit 320 may measure the ESR of the EC device using a high frequency signal. In some embodiments, control unit 320 may be configured to send a high frequency signal, such a sine wave signal, into the EC device circuit to determine the ESR of the IGU. In some embodiments, an AC high frequency signal may be applied to the control voltage terminals, which may normally carry DC voltage, thus allowing measurement of the ESR.

The exact frequency of the high frequency signal used to determine the ESR may vary from embodiment to embodiment. For instance, the sine wave signal may vary from 100 Hz to 10 kHz to over 100 kHz, according to various embodiments. Using the high frequency signal, the control unit may determine an ESR for the IGU and from the ESR may determine (e.g., calculate or estimate) a stack voltage for the IGU.

In some embodiments, control unit 320 may be configured to determine the stack voltage from the ESR and the applied voltage. For instance, the ESR of an EC device may be considered to approximate the difference between the stack voltage and the applied voltage of the EC device circuit, according to some embodiments. The ESR (and therefore the stack voltage estimation) may be determined in real (or near real) time, according to some embodiments.

In some embodiments, determining the stack voltage via an ESR value for the EC device may not require any modifications to existing EC device circuitry. Instead, software control modifications (such may be implemented within control unit 320 and/or stack voltage feedback controller 330) may utilize existing hardware and circuitry to measure the ESR and determine the stack voltage therefrom.

### Determining Stack Voltage by Open Circuit Voltage

While described above as measuring the stack voltage directly or calculating the stack voltage based on an ESR value, in some embodiments, control unit 320 may be configured to determine the stack voltage of the EC device indirectly based at least in part on an open-circuit voltage (OCV) measurement for the EC device. For example, in some embodiments the control unit may be configured to open a circuit on the IGU directly measure an OCV. In some embodiments, the OCV may be represented by the equation:

$$OCV = ( \frac{R l e a k}{R i o n + R l e a k} ) * V c$$

In other embodiments however, control unit 320 may be configured to utilize a high impedance and/or a high resistance to cause the EC device circuit to behave electrically as if there was an actual open circuit. Thus, in some embodiments, the control unit may be configured to apply a high impedance and/or a high resistance to one of the control terminals of the IGU (or other EC device) and to then measure an OCV for the EC device. In some embodiments, the high impedance and/or high resistance may by applied for very short period of time (e.g., just enough time to effectively measure the open-circuit voltage). Thus, in some embodiments, the control unit may perform some functions of, or perform similarly to, a power supply unit for the EC device.

In some embodiments, especially for large IGUs, the measured OCV may represent an edge voltage rather than an overall average stack voltage for the IGU. In general, EC device edge stack voltage and EC device average stack voltage may always be different from each other, according to some embodiments. For instance, during a transition phase (e.g., when changing EC device transmission or tint levels) the different between an EC device's edge stack voltage and the EC device's average stack voltage may be large and that difference may slow down or otherwise interfere with the IGU tinting and/or clearing process (e.g., causing the process to stop too early).

During a holding period (e.g., while maintain a particular tint level), the difference between an EC device's edge stack voltage and average stack voltage may affect the holding accuracy, such as by causing the transmission or tint to be lighter than desired during the holding period, according to some embodiments. Thus, control unit 320 may be configured to determine an average stack voltage differently for different EC devices according to different embodiments. Alternatively, in some embodiments, the edge voltage may be usable as an average stack voltage for the purposes of achieving a desired transmission or tint for an EC device.

In some embodiments, determining the stack voltage via an OCV value for the IGU may not require any modifications to existing EC device circuitry. Instead, software control modifications may utilize existing hardware and circuitry to measure the EC device and determine the stack voltage therefrom. In some embodiments, at low voltage levels, EC device may equal (or approach or approximate) the control voltage (V_{c}).

Returning to FIG. 8, after determining a current stack voltage for the EC device, control unit 320 may then compare the determine stack voltage with the target voltage, as in block 830 and determine a new drive voltage to apply to the EC device based at least in part on that comparison, as in block 840. Thus, control unit 329 may be configured to determine an appropriate voltage to apply to the IGU to affect the change to the desired transmission or tint level. According to some embodiments, the control unit may be configured to determine a new voltage to apply to the EC device based on the determined stack voltage and the target voltage (i.e., a target stack voltage representing the desired tint level of the IGU).

Rather than simply applying a single, unchanging voltage level as in traditional (i.e., prior) techniques, stack voltage based feedback control of an EC device as described herein may continually modify or adjust the driven voltage applied to the EC device based on the how the current stack voltage of the EC devices in response to being driven. As described above, in some embodiments, the techniques described herein may allow an EC device to change tint more rapidly (yet safely) as compared to prior, traditional approaches. Please note however, that the drive voltage level applied to the EC device may not be constantly changing. Instead, control unit 320 may be configured to continually determine what the drive voltage level should be while changing the tint of the EC device. Thus, while control unit 320 may continually determine the drive voltage level to apply to the EC device, the actual voltage level may not change each time control unit determines what the drive voltage level should be. However, in general the drive voltage level may change many times between initiating a new tint level and achieving that target tint level.

Control unit 320 may then apply the adjusted drive voltage level to the EC device, as in block 850. As described above, the control unit may be configured to apply (and continually monitor and/or repeatedly adjust) the applied voltage 406 to the IGU in order to bring the stack voltage up to the appropriate level in order to achieve a desire tint or transmission level within the IGU.

After applying the adjusted drive voltage to the EC device, control unit 320 may return to the start of the functional loop illustrated in FIG. 8. The actual rate at which the control unit may measure the stack voltage and adjust the applied voltage 406 may vary from embodiment to embodiment. In some embodiments, the applied voltage may be adjusted many times a second (e.g., every few milliseconds), while in other embodiments it may be adjusted less than once a second. In yet other embodiments, the applied voltage may effectively be adjusted as part of a voltage circuit that continually adjusts the voltages based on essentially real time feedback.

Once the stack voltage equals (or is within a certain threshold of) the target voltage, the feedback control loop may maintain a holding voltage on the EC device in order to keep the EC device at the desired transmission or tint level. In some embodiments, the voltage level required to maintain a particular transmission or tint level may be lower that voltage levels require to change the transmission or tint level. In some embodiments, control unit 320 may not actually change modes or other state after the IGU achieves the desire transmission or tint level (e.g., as represented by the stack voltage), but instead, continually (i.e., repeatedly) adjusting the applied voltage may both drive the EC device to not only change transmission levels, but to also maintain the current transmission levels. For example, the control unit's applied voltage algorithm may automatically maintain the EC device at its current tint level (as represented by the stack voltage) until the desired level (and therefore the target voltage) changes—at which point the applied voltage will be adjusted.

Please note that the functional block described above are illustrated in FIG. 8 in merely one example arrangement. In other embodiments, the techniques and functionality described above may be performed using different steps in different orders or may be grouped into a different number of steps or may be performed as a single method without distinct steps. For example, in some embodiments, all (or most) of the functionality described above regarding FIG. 8 may be performed by a single feedback control loops, such as by a PI control algorithm, such as might be implemented by control unit 320 and/or stack voltage feedback controller 330. Additionally, some features and/or actions described above as being performed by control unit 320 may, in some embodiments, be performed by one or more other entities, such as by stack voltage feedback controller 330, stack voltage measurement module 510, ESR module 610 and/or OCV module 710.

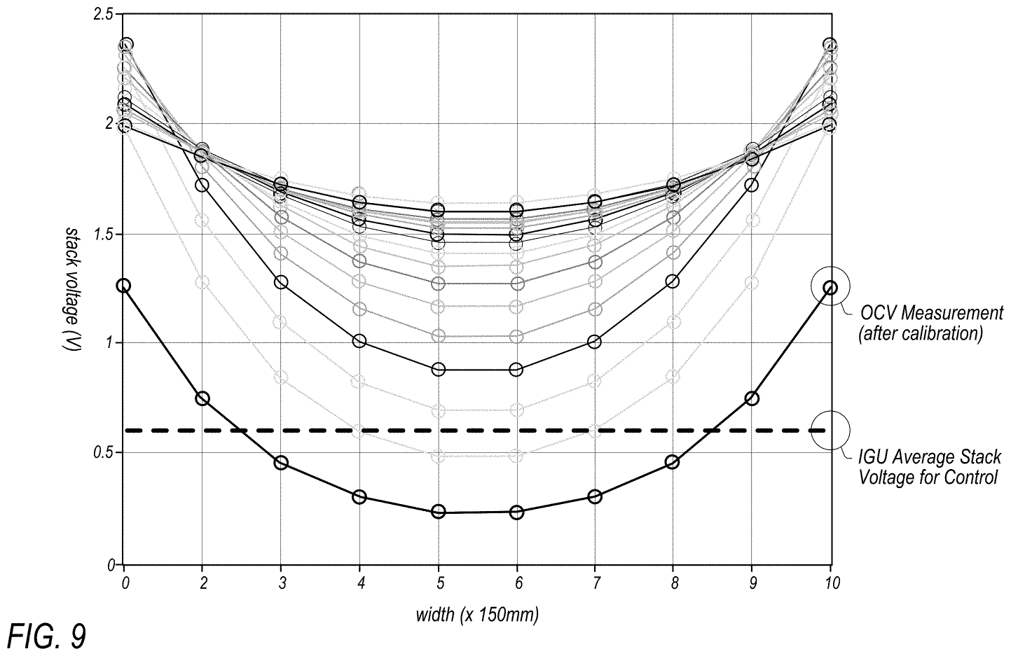

FIG. 9 is a graph illustrating transition uniformity of the OCV measurement compared to a control IGU average stack voltage (for control), according to one example embodiment. In some embodiments, if transmission or tint levels of an IGU are changed (or switched) faster the transition uniformity could be worse than if the transmission levels were changed more slowly. However, this effect is a temporary condition. This effect is not due to any feature of the control system or of the feedback circuit but results from the physical nature of the materials and their arrangement in the EC device.

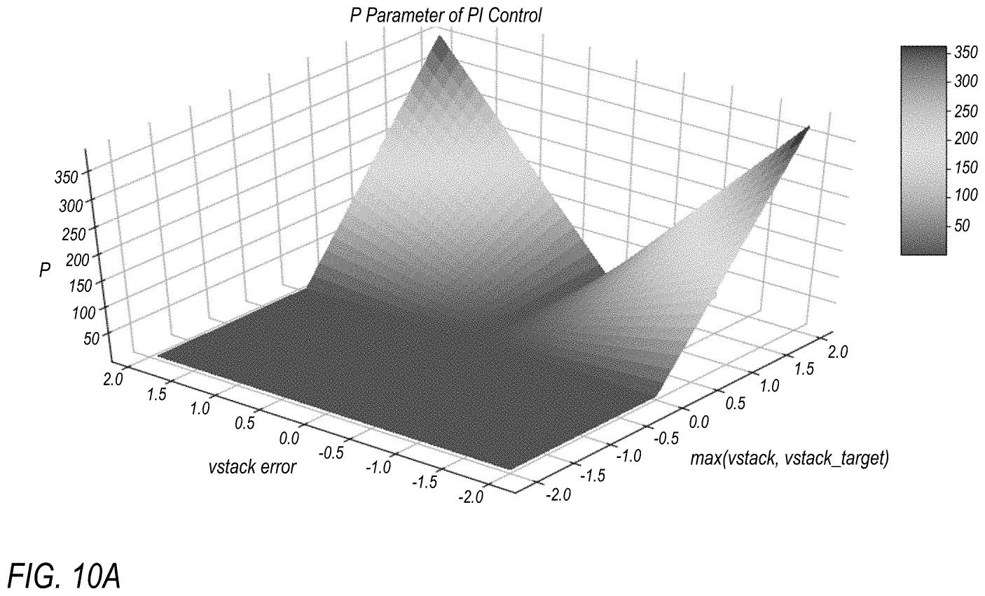

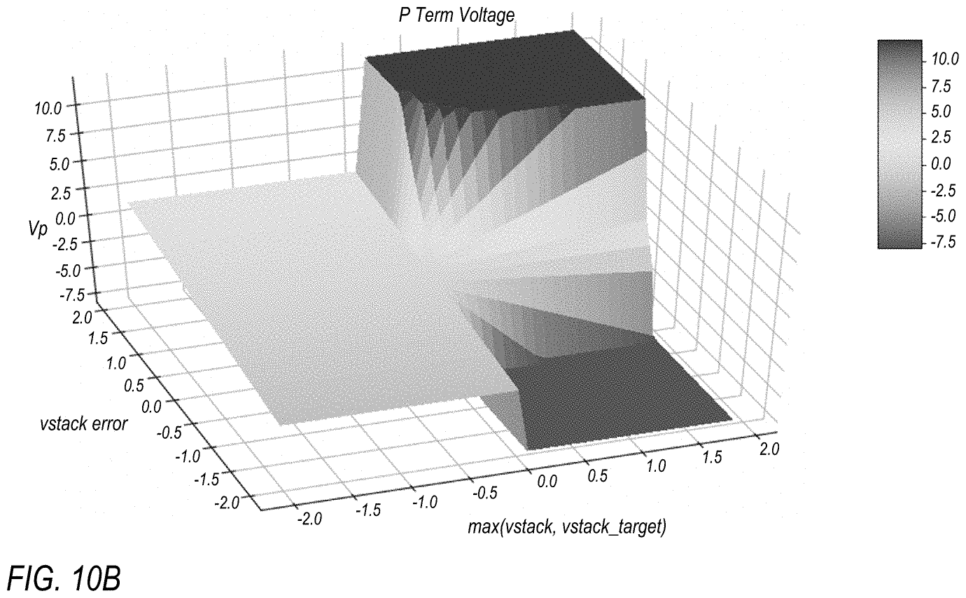

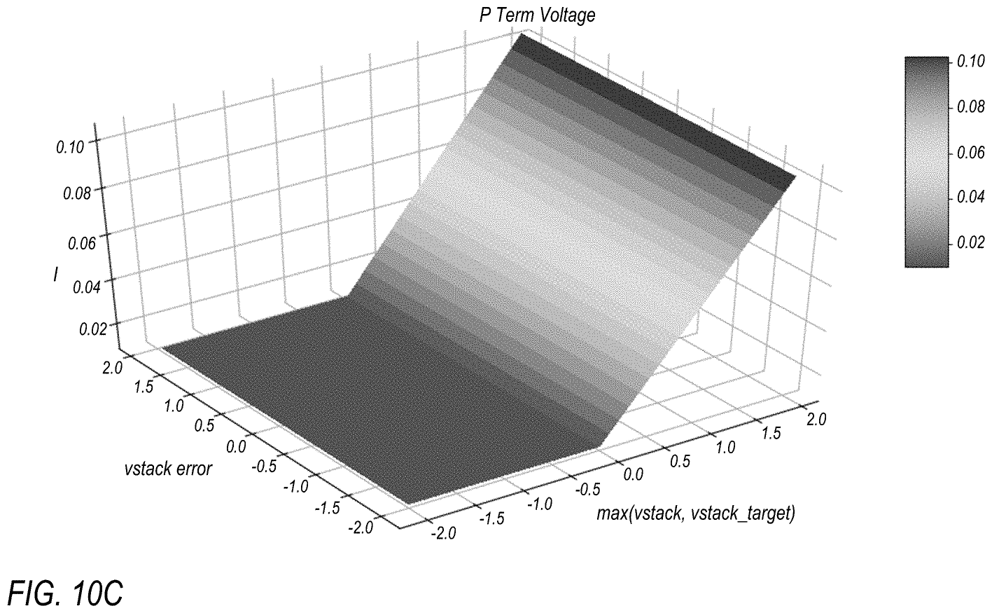

FIG. 10A and FIG. 10B are graphs illustrating an example embodiment of P parameter variation for the example PI control algorithm described above regarding the adaptable PI control for varying stack voltages. Please note that an adaptable PI control algorithm is just possible implementation for managing stack voltage while adapting to various IGU configuration without the use of a large parameter database.

As described above, an adaptable PI control may include a varying P parameter. Varying of the P parameter, such as described above, may be considered a major driving force for IGU transitions (i.e., between different transmission or tint levels), according to some embodiments. In some embodiments, the P parameter may need to be small when the error is small or when the target stack voltage (V_{stack}_{_{target}}) is small but may need to be large for a transition process to reach a maximum (or conversely) a minimum voltage.

In one embodiment the P parameter of an example PI control loop may vary according to the following equation:

P=rₚₑ*|V_{stack}−V_{stack}_{_{target}}|*rₚₑ*max(V_{stack},V_{stack}_{_{target}})+p_{base}

FIG. 10A illustrates the P parameter as it relates to the stack voltage error (i.e., the difference between the stack voltage and the reference or target voltage) and the maximum of the stack voltage and the target stack voltage. FIG. 10B illustrates the voltage level of the P term as it relates to the to the stack voltage error (i.e., the difference between the stack voltage and the reference or target voltage) and the maximum of the stack voltage and the target stack voltage.

FIG. 10C is a graph illustrating the I parameter variation for the example PI control algorithm described above regarding the adaptable PI control for varying stack voltages, according to one embodiment. Please note that an adaptable PI control algorithm is just possible implementation for managing stack voltage while adapting to various IGU configuration without the use of a large parameter database. As described above, an adaptable PI control may include a varying P parameter.

In some embodiments, the I parameter of and adaptable PI control loop may be considered a major driving force for stabilization. In some embodiments, the I parameter may need to be smaller for lower target stack voltages and may need to be larger for higher target stack voltages. In some embodiments, if the I parameter is too high, oscillation may occur around the target stack voltage whereas if the I parameter is too low, the overall stabilization process of the PI control loop may be slower.

In one embodiment the I parameter of an example PI control loop may vary according to the following equation:

I=rᵢₑ*max(V_{stack},V_{stack}_{_{target}})+i_{base}

FIG. 10C illustrates the I parameter as it relates to the stack voltage error (i.e., the difference between the stack voltage and the reference or target voltage) and the maximum of the stack voltage and the target stack voltage.

### Example Computer System

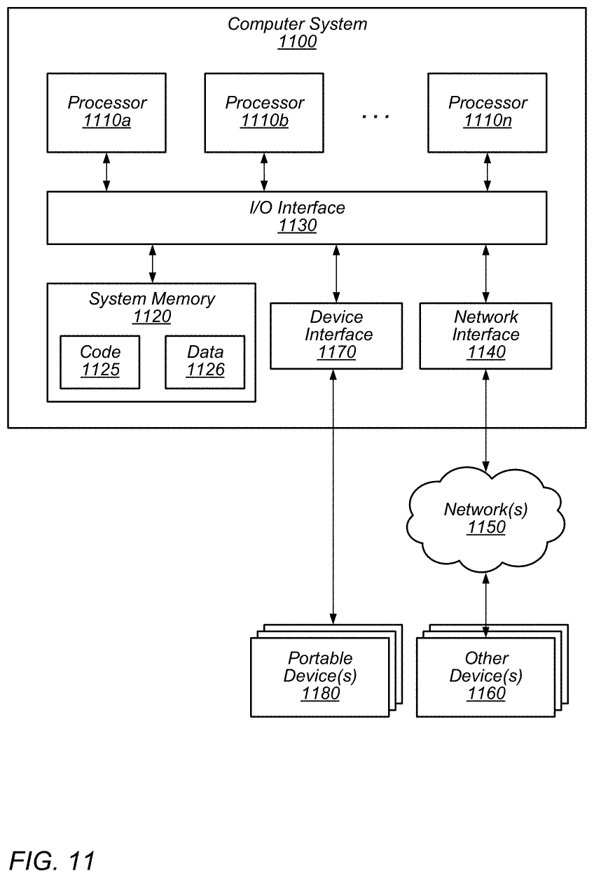

FIG. 11 illustrates an example computer system that may be used in some embodiments.

The methods, features, mechanisms, techniques and/or functionality described herein may in various embodiments be implemented by any combination of hardware and software. For example, in one embodiment, the methods may be implemented by a computer system (e.g., a computer system as in FIG. 11) that includes one or more processors executing program instructions stored on a computer-readable storage medium coupled to the processors. The program instructions may implement the methods, features, mechanisms, techniques and/or functionality described herein. The various methods as illustrated in the figures and described herein represent example embodiments of methods. The order of any method may be changed, and various elements may be added, reordered, combined, omitted, modified, etc.

FIG. 11 is a block diagram illustrating a computer system according to various embodiments, as well as various other systems, components, services or devices described above. For example, computer system 1100 may implement a control unit configured to implement and/or utilize the features, methods, mechanisms and/or techniques described herein, in different embodiments. Computer system 1100 may be any of various types of devices, including, but not limited to, a personal computer system, desktop computer, laptop or notebook computer, mainframe computer system, handheld computer, workstation, network computer, a consumer device, application server, storage device, telephone, mobile telephone, or in general any type of computing device.

Computer system 1100 includes one or more processors 1110 (any of which may include multiple cores, which may be single or multi-threaded) coupled to a system memory 1120 via an input/output (I/O) interface 1130. Computer system 1100 further includes a network interface 1140 coupled to I/O interface 1130. In various embodiments, computer system 1100 may be a uniprocessor system including one processor 1110, or a multiprocessor system including several processors 1110 (e.g., two, four, eight, or another suitable number). Processors 1110 may be any suitable processors capable of executing instructions. For example, in various embodiments, processors 1110 may be general-purpose or embedded processors implementing any of a variety of instruction set architectures (ISAs), such as the x86, PowerPC, SPARC, or MIPS ISAs, or any other suitable ISA. In multiprocessor systems, each of processors 1110 may commonly, but not necessarily, implement the same ISA. The computer system 1100 also includes one or more network communication devices (e.g., network interface 1140) for communicating with other systems and/or components over a communications network (e.g., Internet, LAN, etc.).

For example, a control unit may receive information and/or commands from one or more other devices requesting that one or more EC devices be changed to a different tint level using the systems, methods and/or techniques described herein. For instance, a user may request a tint change via a portable remote control device (e.g., a remote control), a wall mounted (e.g., hard wired) device, or an application executing on any of various types of devices (e.g., a portable phone, smart phone, tablet and/or desktop computer are just a few examples).

In the illustrated embodiment, computer system 1100 is coupled to one or more portable storage devices 1180 via device interface 1170. In various embodiments, portable storage devices 1180 may correspond to disk drives, tape drives, solid state memory, other storage devices, or any other persistent storage device. Computer system 1100 (or a distributed application or operating system operating thereon) may store instructions and/or data in portable storage devices 1180, as desired, and may retrieve the stored instruction and/or data as needed. In some embodiments, portable device(s) 1180 may store information regarding one or EC devices, such as information regarding design parameters, etc. usable by control unit 320 when changing tint levels using the techniques described herein.

Computer system 1100 includes one or more system memories 1120 that can store instructions and data accessible by processor(s) 1110. In various embodiments, system memories 1120 may be implemented using any suitable memory technology, (e.g., one or more of cache, static random-access memory (SRAM), DRAM, RDRAM, EDO RAM, DDR 10 RAM, synchronous dynamic RAM (SDRAM), Rambus RAM, EEPROM, non-volatile/Flash-type memory, or any other type of memory). System memory 1120 may contain program instructions 1125 that are executable by processor(s) 1110 to implement the methods and techniques described herein. In various embodiments, program instructions 1125 may be encoded in platform native binary, any interpreted language such as Java™ bytecode, or in any other language such as C/C++, Java™, etc., or in any combination thereof. For example, in the illustrated embodiment, program instructions 1125 include program instructions executable to implement the functionality of a control unit, a stack voltage feedback controller, a stack voltage measurement module, an ESR module, an OCV module, a supervisory control system, local controller, project database, etc., in different embodiments. In some embodiments, program instructions 1125 may implement a control unit configured to implement and/or utilize the features, methods, mechanisms and/or techniques described herein, and/or other components.

In some embodiments, program instructions 1125 may include instructions executable to implement an operating system (not shown), which may be any of various operating systems, such as UNIX, LINUX, Solaris™, MacOS™, Windows™, etc. Any or all of program instructions 1125 may be provided as a computer program product, or software, that may include a non-transitory computer-readable storage medium having stored thereon instructions, which may be used to program a computer system (or other electronic devices) to perform a process according to various embodiments. A non-transitory computer-readable storage medium may include any mechanism for storing information in a form (e.g., software, processing application) readable by a machine (e.g., a computer). Generally speaking, a non-transitory computer-accessible medium may include computer-readable storage media or memory media such as magnetic or optical media, e.g., disk or DVD/CD-ROM coupled to computer system 1100 via I/O interface 1130. A non-transitory computer-readable storage medium may also include any volatile or non-volatile media such as RAM (e.g., SDRAM, DDR SDRAM, RDRAM, SRAM, etc.), ROM, etc., that may be included in some embodiments of computer system 1100 as system memory 1120 or another type of memory. In other embodiments, program instructions may be communicated using optical, acoustical or other form of propagated signal (e.g., carrier waves, infrared signals, digital signals, etc.) conveyed via a communication medium such as a network and/or a wireless link, such as may be implemented via network interface 1140.

In one embodiment, I/O interface 1130 may coordinate I/O traffic between processor 1110, system memory 1120 and any peripheral devices in the system, including through network interface 1140 or other peripheral interfaces, such as device interface 1170. In some embodiments, I/O interface 1130 may perform any necessary protocol, timing or other data transformations to convert data signals from one component (e.g., system memory 1120) into a format suitable for use by another component (e.g., processor 1110). In some embodiments, I/O interface 1130 may include support for devices attached through various types of peripheral buses, such as a variant of the Peripheral Component Interconnect (PCI) bus standard or the Universal Serial Bus (USB) standard, for example. In some embodiments, the function of I/O interface 1130 may be split into two or more separate components, such as a north bridge and a south bridge, for example. Also, in some embodiments, some or all of the functionality of I/O interface 1130, such as an interface to system memory 1120, may be incorporated directly into processor 1110.

Network interface 1140 may allow data to be exchanged between computer system 1100 and other devices attached to a network, such as other computer systems 1160. In addition, network interface 1140 may allow communication between computer system 1100 and various I/O devices and/or remote storage devices. Input/output devices may, in some embodiments, include one or more display terminals, keyboards, keypads, touchpads, scanning devices, voice or optical recognition devices, or any other devices suitable for entering or retrieving data by one or more computer systems 1100. Multiple input/output devices may be present in computer system 1100 or may be distributed on various nodes of a distributed system that includes computer system 1100. In some embodiments, similar input/output devices may be separate from computer system 1100 and may interact with one or more nodes of a distributed system that includes computer system 1100 through a wired or wireless connection, such as over network interface 1140. Network interface 1140 may commonly support one or more wireless networking protocols (e.g., Wi-Fi/IEEE 802.11, or another wireless networking standard). However, in various embodiments, network interface 1140 may support communication via any suitable wired or wireless general data networks, such as other types of Ethernet networks, for example. Additionally, network interface 1140 may support communication via telecommunications/telephony networks such as analog voice networks or digital fiber communications networks, via storage area networks such as Fibre Channel SANs, or via any other suitable type of network and/or protocol. In various embodiments, computer system 1100 may include more, fewer, or different components than those illustrated in FIG. 11 (e.g., displays, video cards, audio cards, peripheral devices, other network interfaces such as an ATM interface, an Ethernet interface, a Frame Relay interface, etc.)

The various methods as illustrated in the figures and described herein represent example embodiments of methods. The methods may be implemented manually, in software, in hardware, or in a combination thereof. The order of any method may be changed, and various elements may be added, reordered, combined, omitted, modified, etc.

Although the embodiments above have been described in considerable detail, numerous variations and modifications may be made as would become apparent to those skilled in the art once the above disclosure is fully appreciated. It is intended that the following claims be interpreted to embrace all such modifications and changes and, accordingly, the above description to be regarded in an illustrative rather than a restrictive sense.

What is claimed is:

1. A system for controlling operations of an electrochromic (EC) device, comprising:
a control unit coupled to the EC device, wherein the control unit is configured to transition the EC device from a first transmission level to a target transmission level, wherein to transition the EC device the control unit is configured to repeatedly:
determine a stack voltage for the EC device;
compare the determined stack voltage to a target voltage for the EC device;
determine a drive voltage for the EC device based at least in part on said comparing the determined stack voltage to the target voltage for the EC device; and
apply the drive voltage to the EC device.

2. The system of claim 1, wherein to determine the drive voltage, the control unit is further configured to adjust one or more parameters of a closed-loop feedback control system based on the determined stack voltage, wherein the closed-loop feedback control system is configured to calculate the drive voltage.

3. The system of claim 2, wherein the one or more parameters comprise a P parameter and an I parameter of a proportional integral derivative (PID) control mechanism.

4. The system of claim 1, wherein to measure the stack voltage of the EC device the control unit is configured to:
read the stack voltage directly from a measurement point within the EC device directly connecting a top transparent conductive oxide (TCO) layer with a bottom TCO layer.

5. The system of claim 1, wherein to measure the stack voltage of the EC device the control unit is configured to:
measure an equivalent series resistance (ESR) level for the EC device; and
determine the stack voltage based at least in part on the measured ESR level and a previously applied drive voltage.

6. The system of claim 5, wherein to measure the ESR level, the control unit is configured to:
apply a using a high frequency signal to a circuit of the EC device;
measure the ESR level based on the high frequency signal; and
determine the stack voltage based at least in part on combining the measured ESR level with a previously applied drive voltage.

7. The system of claim 1, wherein to determine the stack voltage of the EC device the control unit is configured to:
create an open circuit condition for a period of time on a circuit of the EC device;
measure an open circuit voltage level during the open circuit period of time; and
determine the stack voltage from the open circuit voltage level.

8. The system of claim 7, wherein to create the open circuit condition, the control unit is configured to:
apply a high impedance or a high resistance to a circuit of the EC device, wherein while the high impedance or high resistance is applied, the circuit behaves electrically as an open circuit.

9. A computer implemented method for controlling operations of an electrochromic (EC) device, comprising:
transitioning the EC device from a first transmission level to a target transmission level, comprising repeatedly:
determining a stack voltage for the EC device;
comparing the determined stack voltage to a target voltage for the EC device;
determining a drive voltage for the EC device based at least in part on said comparing the determined stack voltage to the target voltage for the EC device; and
applying the drive voltage to the EC device.

10. The method of claim 9, wherein determining the drive voltage comprises adjusting, based on the determined stack voltage, one or more parameters of a closed-loop feedback control system configured to calculate the drive voltage.

11. The method of claim 10, wherein the one or more parameters comprise a P parameter and an I parameter of a proportional integral derivative (PID) control mechanism.

12. The method of claim 9, wherein determining the stack voltage of the EC device comprises:
reading the stack voltage directly from a measurement point within the EC device directly connecting a top transparent conductive oxide (TCO) layer with a bottom TCO layer.

13. The method of claim 9, wherein determining the stack voltage comprises:
measuring an equivalent series resistance (ESR) level for the EC device; and
determining the stack voltage based at least in part on the measured ESR level and a previously applied drive voltage.

14. The method of claim 13, wherein measuring the ESR level comprises:
applying a using a high frequency signal to a circuit of the EC device;
measuring the ESR level based on the high frequency signal; and
calculating the stack voltage based on at least in part combining the measured ESR level with a previously applied drive voltage.

15. The method of claim 9, wherein measuring the stack voltage comprises:
creating an open circuit condition for a period of time on a circuit of the EC device;
measuring an open circuit voltage level during the open circuit period of time; and
determining the stack voltage from the open circuit voltage level.

16. The method of claim 15, wherein creating the open circuit condition comprises:
applying a high impedance or a high resistance to a circuit of the EC device, wherein while the high impedance or high resistance is applied, the circuit behaves electrically as an open circuit.

17. One or more non-transitory, computer-readable, storage media storing program instructions that when executed on or across one or more processors cause the one or more processors to:
transition the EC device from a first transmission level to a target transmission level, wherein to transition the EC device the program instructions cause the one or more processors to repeatedly:
determine a stack voltage for the EC device;
compare the determined stack voltage to a target voltage for the EC device;
determine a drive voltage for the EC device based at least in part on said comparing the determined stack voltage to the target voltage for the EC device; and
apply the drive voltage to the EC device.

18. The media of claim 17, further comprising instructions than when executed on or across the one or more processors further cause the one or more processors to:
adjust one or more parameters of a closed-loop feedback control system based on the determined stack voltage, wherein the closed-loop feedback control system is configured to calculate the drive voltage.

19. The media of claim 18, wherein the one or more parameters comprise a P parameter and an I parameter of a proportional integral derivative (PID) control mechanism.

20. The media of claim 17, wherein to determine the stack voltage of the EC device the program instructions further cause the one or more processors to perform one of:
read the stack voltage directly from a measurement point within the EC device directly connecting a top transparent conductive oxide (TCO) layer with a bottom TCO layer;
measure an equivalent series resistance (ESR) level for the EC device; or
apply a high impedance or a high resistance to a circuit of the EC device, wherein while the high impedance or high resistance is applied, the circuit behaves electrically as an open circuit.
